(19) United States
(12) Patent Application Publication
(10) Pub. No.: US 2008/0023900 A1
(43) Pub. Date: Jan. 31, 2008

(54) Separating and holding apparatus

(75) Inventors: Masanori Sohka, Atsugi-shi (JP); Katsuya Enomoto, Atsugi-shi (JP); Yoshihiro Kita, Atsugi-shi (JP)

Correspondence Address: BIRCH STEWART KOLASCH & BIRCH, PO BOX 747, FALLS CHURCH, VA, 22040-0747, US

(73) Assignee: AMADA ENGINEERING CO., LTD.

(21) Appl. No.: 11/711,745

(22) Filed: Feb. 28, 2007

(30) Foreign Application Priority Data
Jul. 26, 2006 (JP) 2006-203662

(51) Int. Cl. B23Q 1/25

(52) U.S. Cl. 269/73

(57) ABSTRACT

The separating and holding apparatus of the invention is for separating products which have been cut out of a workpiece, and a remainder (skeleton) of the workpiece from each other, and for carrying and holding the products and the remainder. The apparatus includes a workpiece holding table, skeleton holding table provided beside the workpiece holding table, truck unit, product holding table provided on the truck unit, skeleton holding member provided below the product holding table. The truck unit horizontally moves so as to have the product holding table above the workpiece holding table and the skeleton holding table, in turn. The skeleton holding member lifts the skeleton from the workpiece on the workpiece holding table, separates the skeleton from the products. The skeleton is transferred to the skeleton holding table, and the products are deposited on the product holding table by the function of the product holding member.

### CROSS REFERENCE TO RELATED APPLICATIONS AND INCORPORATION BY REFERENCE

This application is based upon and claims the benefit of priority from the prior Japanese Patent Application No. 2006-203662, filed on Jul. 26, 2006; the entire content of which is incorporated herein by reference.

### BACKGROUND OF THE INVENTION

1. Field of the Invention

The present invention relates to a separating and holding apparatus for separating products which have been cut out of a workpiece and a remainder of the workpiece (hereinafter, referred to as “remainder”) from each other, and for carrying and holding the products and the remainder.

2. Discussion of the Related Art

When a workpiece such as a metal plate or sheet is cut into an appropriate product shape, it is necessary that the product and the remainder of the workpiece are separated from each other. Then, the products and the remainder are separately stored.

For facilitating the above separation and holding operation, many types of separating and holding apparatuses have been proposed. In these apparatuses, workpieces which have already been cut e.g., by means of a laser processor, into products and the remainders, are separated into a group of products and a group of remainders. After the separation, the products and the remainders are separately stored in the separating and holding apparatus. It is possible to cut one or more products out of a single workpiece, and the remainder of the workpiece is usually maintained as one piece. From appearance, the remainder of the workpiece, which has holes or cuttings in the form of cut products, is also referred to as a skeleton.

According to the technology in Japanese Kokai Publication 2000-1126887, it is possible to separate products and skeleton by using an apparatus including first and second roller tables placed in series, with a space between the first and the second roller tables.

In the first place, a workpiece including products and a skeleton are placed on the first roller table. In the second place, the skeleton is removed from the first roller table by ends of the skeleton being clamped and the skeleton is transferred to the second roller table. On the other hand, the products downwardly move into the space between the first and the second roller tables. In this way, the products are separated from the skeleton.

Alternatively, Japanese Kokai Publication 2001-105182 discloses another apparatus used for separating and holding workpieces. The apparatus has a transporting stage, a fork member, a skeleton clamp, a track, lifter and a scrap box. The stage is for holding and transferring a workpiece, which is mainly in the form of a metal plate, in and out of a heat cutter. After the workpiece is cut into products and the skeleton and taken out of the heat cutter, the stage holds and transfers the workpiece to the fork member. The fork member moves in the direction of the stage and is inserted between the workpiece and the stage. Then, the fork member holds up the workpiece above the stage. For clamping the skeleton of the workpiece placed on the fork member, one or more clamps are used. The track provided beneath the stage runs across the stage so that the stage is located at the center of the track with respect to the length thereof. Furthermore, a lifter and a scrap box run on the track toward and away from the stage.

In the above apparatus, the workpiece after processing is lifted by the fork member and is transferred to the location above the transporting stage. The skeleton on the fork member is held up by means of the skeleton clamp, and the lifter runs to a position below the stage. Then, the products fallen down to the lifter by moving/pulling the fork member aside of the stage. In this way, the products are collected on the lifter. The lifter is then moved away from the stage by running on the track in the direction away from the stage. Thereafter, a scrap box located on the other part of the track is moved to a position below the stage. The skeleton clamped by the skeleton clamp is released therefrom, fallen down and maintained in the scrap box.

According to the technology disclosed in Japanese Kokai Publication 2000-1126887, the products are moving to a space between the first and second roller tables, with the skeleton being clamped at the ends and brought from the first roller table to the second roller table. When falling down, the product is inclined with a part of the product being lower than the other part thereof. Then the inclination angle is gradually getting larger, and finally the products fall down. Depending on many reasons such as the shape of the product and the thickness of the workpiece, it is possible that the products are caught by the skeleton and that the product cannot be completely separated therefrom.

Based on the technology disclosed in Japanese Kokai Publication 2001-105182, the products successively fall down from the free end of the fork member, while the fork member is detached/extracted from the lower surface of the workpiece and is moved to the side of the stage. Since the inclination angles of the falling down products are gradually increased also herein, it is possible that the products are caught by the skeleton and that the product cannot be completely separated therefrom, depending on the shape of the product, the thickness of the material, or the like.

In addition to the above, in Japanese Kokai Publication 2001-105182, it is necessary to have a large space on both sides of the stage, since the track extends outside directions from the stage, with the lifter and the scrap box being provided thereon. Thus, the entire apparatus is large, and the space for accepting the apparatus is not always available.

Moreover, the lifter and the scrap box run on the track in turn, because only one of them is acceptable below the stage at a time, and it is not possible to provide a plurality of lifters and a plurality of scrap boxes on a single track. Accordingly, the number of the workpieces which can be subjected to the separating process is limited. It is difficult to enlarge the processing capability based on this system.

If the above-mentioned apparatus is installed additionally to an existing heat cutter, it is necessary to supply a skeleton clamp to a stage in the heat cutter, for carrying plate-shaped workpieces. This could be a large-scaled remodeling, that requires a long construction period, large cost.

### OBJECT AND SUMMARY OF THE INVENTION

It is therefore an object of the present invention to provide a small-sized separating and holding apparatus for separating products which have been cut out of a workpiece and a skeleton of the workpiece from each other, and for carrying and holding the products and the skeleton, with the reliability for separating skeletons from the products being increased.

The separating and holding apparatus of the present invention comprises a workpiece holding table for holding the workpiece including the products and the skeleton; a skeleton holding table for holding the skeleton, the skeleton holding table being provided beside the workpiece holding table; a truck unit which moves horizontally between a forward position and a return position, an upper part of the truck unit being located above the workpiece holding table and the skeleton holding table in the forward position and the return position, respectively; a product holding table for holding the products separated from the workpiece, the product holding table being provided on the upper part of the truck unit; a skeleton holding member for holding the skeleton provided on the skeleton holding table at the forward position, the skeleton holding member provided below the upper part of the truck unit, for holding the skeleton at a height relatively higher than that of the workpiece holding table so as to be spaced apart from the products, for carrying the skeleton to the return position by the movement of the truck unit, and for depositing the skeleton on the skeleton holding table by releasing the skeleton therefrom at the return position; and a product holding member for holding the products provided on the workpiece holding table by lifting the products, when the truck unit is provided at the return position at a height higher than that of the product holding table, and for causing the products to fall down to the product holding table when the truck unit is provided at the forward position.

### BRIEF DESCRIPTION OF THE DRAWINGS

A more complete appreciation of the invention and many of the attendant advantages thereof will be readily perceived as the same becomes better understood by reference to the following detailed description when considered in connection with the accompanying drawings, wherein:

FIG. 1 is a perspective view of a laser processing apparatus wherein a separating and holding apparatus of the present invention is installed;

FIG. 2 is a plane view of a laser processing apparatus wherein a separating and holding apparatus of the present invention is installed;

FIG. 3 is a front view of a laser processing apparatus wherein a separating and holding apparatus of the present invention is installed;

FIG. 4 is a side view of a laser processing apparatus wherein a separating and holding apparatus of the present invention is installed;

FIGS. 5A to 5C are schematic diagrams of a product holding member and a pallet changer for explaining an operation of lifting the workpiece from a pallet;

FIGS. 6A to 6C are schematic diagrams of a product holding member and a workpiece holding table for explaining an operation of depositing the workpiece on the workpiece holding table;

FIGS. 7A and 7B are schematic diagrams of a truck unit and a workpiece holding table for explaining an operation of separating skeletons from products;

FIGS. 8A and 8B are schematic diagrams of a truck unit and a skeleton holding table for explaining an operation of depositing skeletons on a skeleton holding table;

FIGS. 9A and 9B are schematic diagrams of a product holding member and a workpiece holding table for explaining an operation of lifting products from the workpiece holding table; and

FIGS. 10A and 10B are schematic diagrams of a product holding member, truck unit and a workpiece holding table for explaining an operation of depositing the products on a product holding table.

### DETAILED DESCRIPTION OF THE INVENTION

Other features of this invention will become apparent in the course of the following description of exemplary embodiments, which are given for illustration of the invention and are not intended to be limiting thereof.

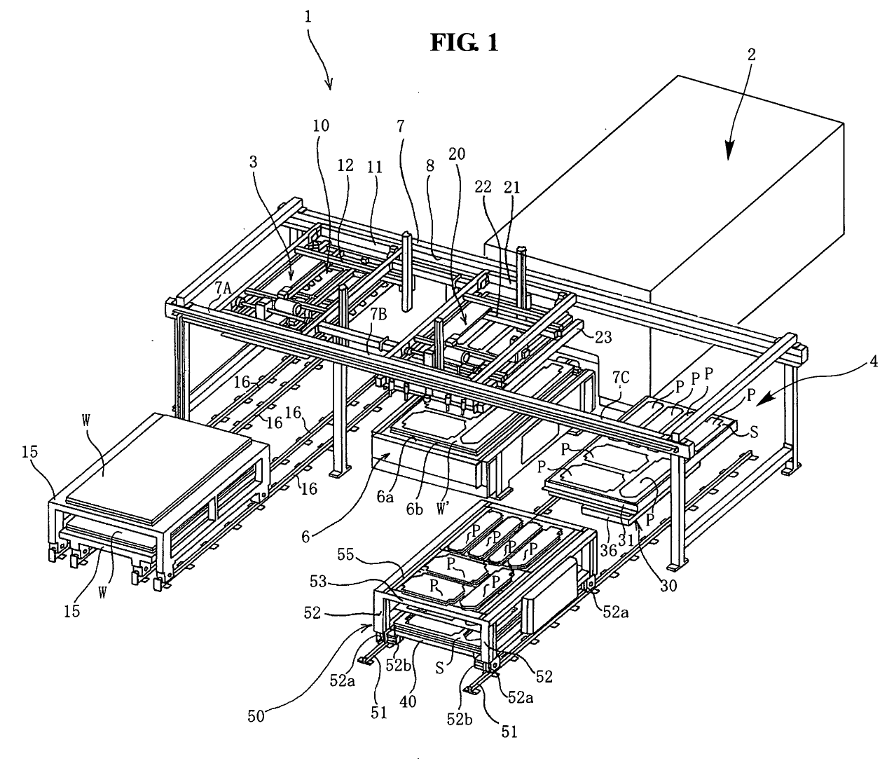

FIGS. 1 to 4 are respectively a perspective view, plane view, front view, and a right-side view of an entire laser processing apparatus 1, wherein a separating and holding apparatus 4 of the present invention is installed.

The laser processing apparatus 1 includes a laser processing unit 2, a transfer unit 3, and a separating and holding apparatus 4. The transfer unit 3 is used for sending a workpiece W before cutting operation into the laser processing unit 2. The separating and holding apparatus 4 is an apparatus for carrying a workpiece W′ which has been cut by means of the laser processing unit 2 out of the unit 2, separating the product P and the skeleton S from each other, and holding these.

The laser processing unit 2 performs a cutting operation on a workpiece W in the shape of a plate. Namely, the workpiece W before cutting is subjected to a cutting operation to obtain a products P and a skeleton S. It is preferable that the products are punched out of the workpiece, and. Therefore, a workpiece W′ after cutting operation is provided, wherein products S in the same or different shapes are placed in a skeleton. At this stage, the workpiece W′ after the cutting operation looks similar to the workpiece W before the operation because the products and the skeleton are maintained together. As the laser processing unit 2, it is possible to use an existing equipment. Therefore, detailed explanation of the laser processing unit 2 is omitted.

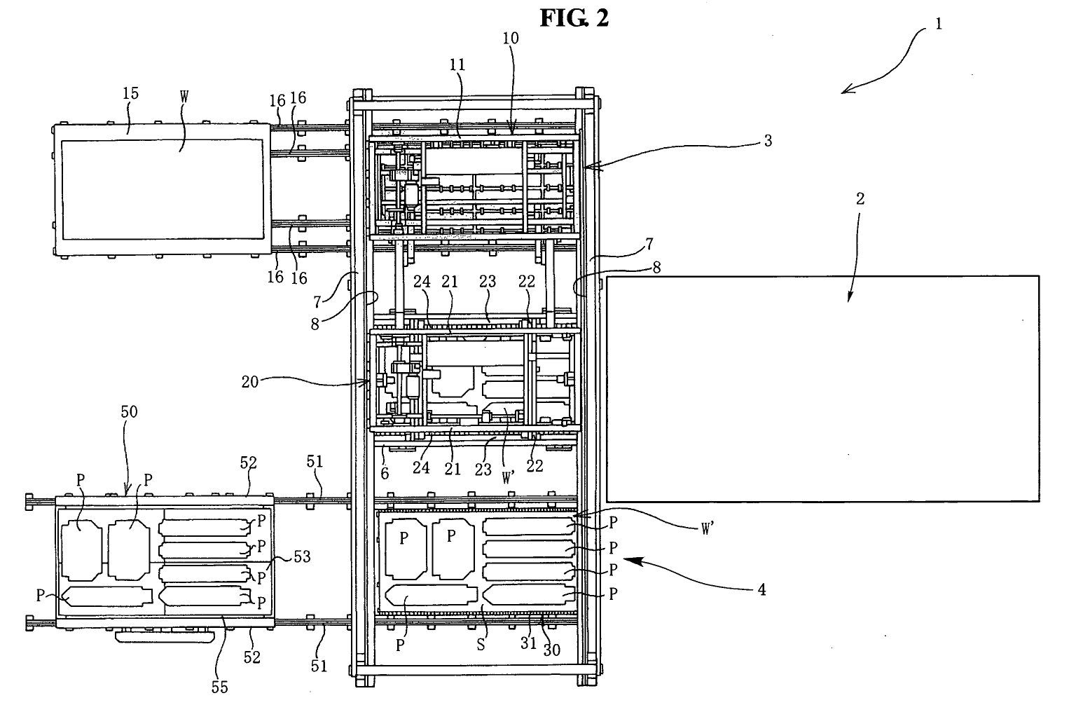

As shown in FIGS. 1 and 2, a pallet changer 6 is provided beside the laser processing unit 2. The pallet changer 6 includes two pallets 6a, and sends the workpiece W the laser processing unit 2 for the cutting operation, and to receive the workpiece W′ from the laser processing unit 2 after the cutting operation.

Each of the pallets 6a makes reciprocating movement between the pallet changer 6 and the laser processing unit 2. An upper surface 6b of the pallet 6a is formed like a pin holder having a plurality of protrusions with a predetermined height, which are arranged throughout the upper surface 6b. Protrusions on the upper surface 6b are aligned in the form of lines which are parallel with each other, and the aligned protrusions defines a gap therebetween for receiving tines of forks 24 in a fork unit 20. Moreover, the lines formed by the aligned protrusions extend in a transverse direction with respect to the direction of the reciprocating movement of the pallet 6a.

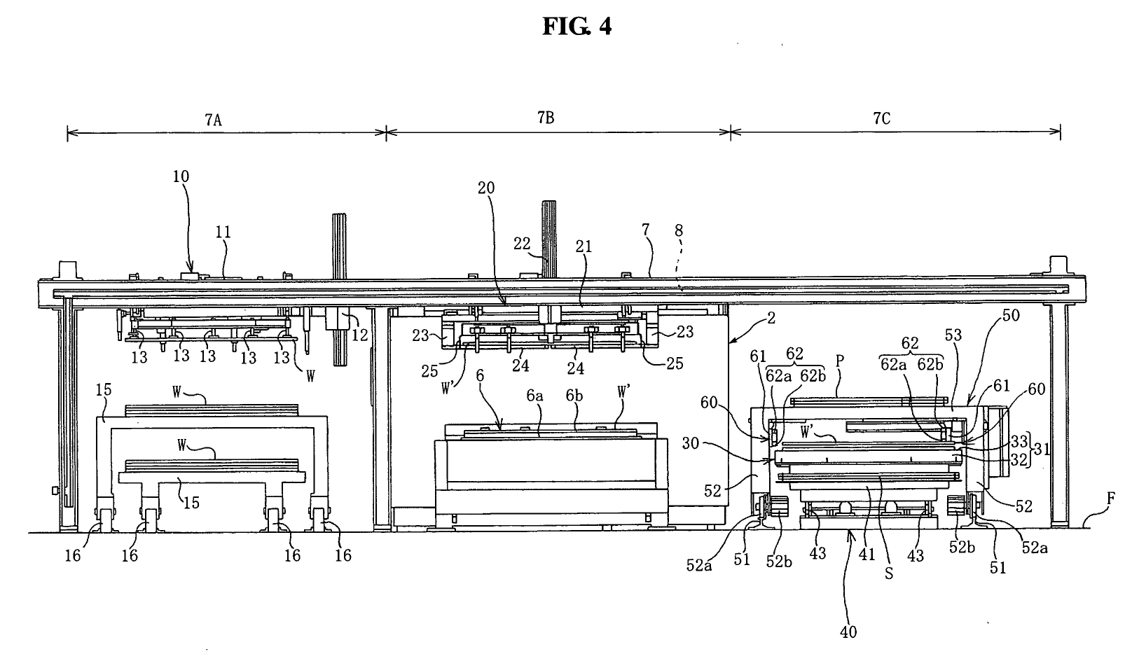

Above the pallet changer 6, a transportation way 7 is provided for supporting a single-sheet receiving member 10 of the transfer unit 3 and the fork unit 20, so that the single-sheet receiving member 10 and the fork unit 20 move reciprocatingly on the transportation way 7. The transportation way 7 includes a pair of horizontally extending rails 8. The rails 8 horizontally extend in a transverse direction with respect to the directions that the workpiece is transported between the laser processing unit 2 and the pallet changer 6. The rails 8 extend in parallel with each other at the same height from the wall. As shown in FIGS. 1 and 4, the rails have a middle part 7B which corresponds to the location above the pallet changer 6, an upper stream part 7A which is on a rear side with respect to the pallet changer 6, and a downstream part 7C which is on a front side with respect to the pallet changer 6.

A single-sheet receiving member 10 of the transfer unit 3 has horizontally movable transport member 11, a vertically movable transport member 12, and a support member 13 (FIG. 4). The horizontally movable transport member 11 supported by a pair of the transporting rails 8 is configured to move reciprocatingly between the upper stream part 7A and the middle part 7B. The vertically movable transport member 12 is provided on the horizontally movable transport member 11 and moves upwardly and downwardly. The support member 13 is for suspending a workpiece W by adsorbing to an upper surface of the workpiece W. By the support member 13, the workpiece W before cutting operation is transported by suspending with surfaces of the workpiece W being maintained to be horizontal.

After transferring the horizontally movable transport member 11 to the upper stream part 7A of the transportation way 7 and causing the vertically movable transport member 12 to move downwardly, the workpiece W placed on a transfer unit 15 is supported by the support member 13, by absorbing the upper surface thereof. Then, the vertically movable transport member 12 is transferred downwardly with a single workpiece W taking up from the transfer unit 15. The horizontally movable transport member 11 is transferred to the middle part 7B of the transportation way 7, and is held above the pallet changer 6. Then, the vertically movable transport member 12 is transferred downwardly, and the workpiece W absorbed and suspended by means of the support member 13 is detached therefrom. Accordingly, the workpiece W before cutting operation is deposited on a pallet 6a of the pallet changer 6.

The transfer units 15 run by the guidance of tracks 16 provided on a floor F so as to move into and exit from the upper stream part 7A. Each of the transfer units 15 carries thereon a plurality of workpieces W before processing and runs on each of the tracks 16 reciprocatingly. In an embodiment of the present invention, two tracks 15 are used, for making it possible to selectively use two kinds of materials. However, it is possible to use only a single track 15.

The separating and holding apparatus 4 includes a fork unit (product holding member) 20, a workpiece holding table 30, a skeleton holding table 40, and a truck unit 50.

The fork unit 20 holds and carries workpiece W′ (after cutting operation) and products P. The fork unit 20 includes a horizontally movable transport member 21, a vertically movable transport member 22, a pair of horizontal arms 23, and forks 24. The horizontally movable transport member 21 is supported by the transportation way 7 containing a pair of transporting rails 8, and moves between the middle part 7B and the lower stream part 7C of the transportation way 7, reciprocatingly. The vertically movable transport member 22 is supported by the horizontally movable transport member 21 for making an up and down movement. The arms 23 extend to be in parallel with each other, having are a space therebetween, so that one arm is provided on an up stream side of the transportation way 7 and the other arm is provided on a down stream side thereof. The arms 23 are supported by the vertically movable transport member 22 and make an opening and a shutting movement. The arms 23 are brought toward each other by the opening movement, and the arms move apart from each other by the shutting movement. The forks 24 are provided on the horizontal arms 23 and horizontally protrude toward each other.

Each of the forks 24 has a plurality of tines having an arrangement similar to a comb. When the horizontal arms 23 make an opening movement, the arms 23 move away so as to have a space therebetween, which is broader than the width of the pallet 6a of the pallet changer 6. Then, the arms 23 located on the upper and lower stream sides make a closing movement, and the tines of the forks 24 are inserted between the gaps defined between the aligned protrusions of the pallet 6a. By the closing movement, the forks 24 contact the lower surface of the workpiece W′ on the pallet 6a.

In the above-mentioned state, the vertically movable transport member 22 is moved upwardly. Accordingly, the workpiece W′ on the pallet 6a is lifted from the pallet changer 6 by the forks 24, and is transported from the middle part 7B to the lower stream part 7C of the transportation way 7 due to the function of the horizontally movable transport member 21.

Moreover, the vertically movable transport member 22 of the fork unit 20 is provided with back plates 25, as shown in FIG. 4. The back plates 25 extend downwardly from the vertically movable transport member 22 and to the spaces between the tines of the forks 24. Each of the back plates 25 includes strips extending in a vertical direction for accepting the tines of the forks 24 therebetween. Accordingly, the back plates 25, which face the lateral sides of the pallet 6a, move downwardly by the downward movement of the vertically movable transport member 22, with the tines of the forks 24 being inserted between the strips. Thereafter, the forks 24 make the opening movement. By the opening movement of the arms 23, the products P on the forks 24 are coming into contact with the back plates 25 and the products P fall down from the forks 24. In this way, the forks 24 can be extracted from the lower side of the products P, without holding the products P thereon.

In the present invention, it is possible that the fork unit 20 is linked with the single-sheet receiving member 10, and that the fork unit 20 and the single-sheet receiving member 10 make a reciprocating movement on the transportation way 7, as an integral unit.

The workpiece holding table 30 is situated on the lower stream part 7C of the transportation way 7, and is composed of a table plate 31 which horizontally extends, and a lift unit (ascending and descending member) 36 for moving the table plate 31 upwardly and downwardly, with the table plate 31 being maintained horizontally.

The table plate 31 has a base part 32, which is in the form of rectangle in a plane view, having almost the same size with the workpiece W′. Similar to the pallet 6a of the pallet changer 6, a plurality of protrusions 33 with a predetermined height are protruded in an upper direction throughout the upper surface of the base part 32. Namely, protrusions 33 are aligned in the form of lines which are parallel with each other, and gaps are defined between the lines of aligned protrusions.

The protrusions 33 are aligned in the same direction as the protrusions of the pallet changer 6. The gaps between the protrusions 33 are broad enough to accept the tines of the forks 24. Moreover, the height of the protrusions 33 are determined so as to have the upper surface of the fork 24 lower than the tops of the protrusions 33 when the fork 24 having the workpiece W′ thereon is brought to a lower position.

The protrusions 33 on the upper surface of the fork 24 are arranged in the form of lines extending in the same direction as the forks 24 move, whereby the fork 24 can be inserted to and extracted from the gaps defined by the protrusions.

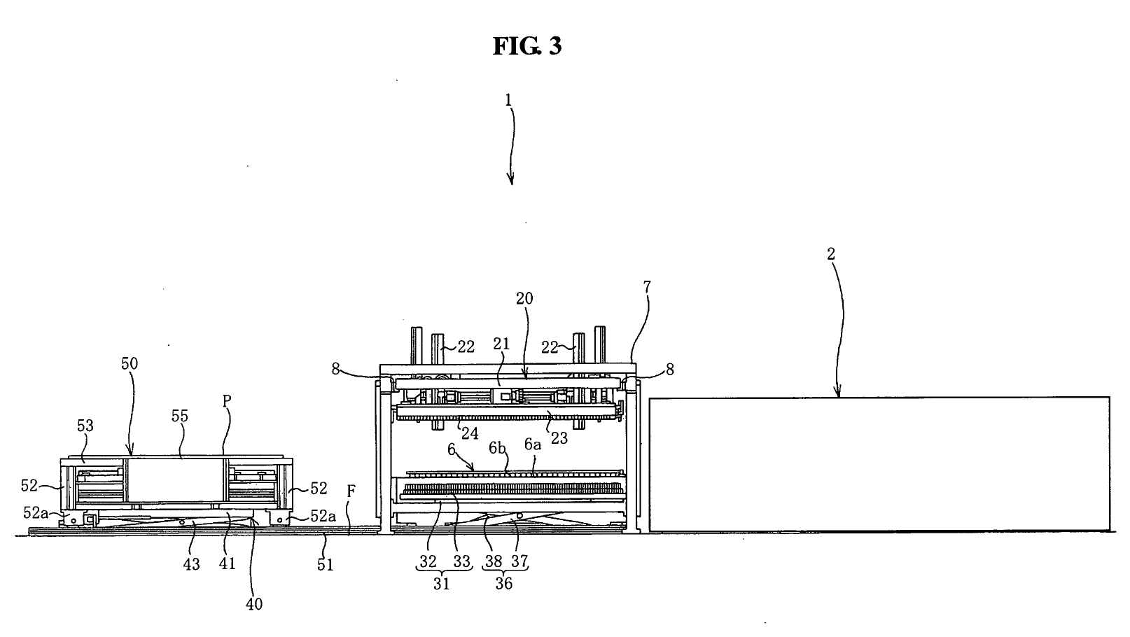

FIG. 3 shows that the lift unit 36 is composed of a cross arms 37 and a hydraulic cylinder 38. It is also possible to use a plurality of cylinders 38. The cross arms 37 are interposed between the floor F and the table plate 31, with the lower ends of the arms 37 supported on the floor F, and the upper end thereof supported by the table plate 31. The hydraulic cylinder 38 is used for controlling the movement of the cross arms 37. The lift unit 36 causes the table 31 to perform ascent and descent movements, with horizontally maintaining the table plate 31. It is possible to stop the movement when the table plate 31 reaches an appropriate height.

Then, the fork unit 20 carrying workpiece W′ moves to the lower stream part 7C of the transferring route 7, and stops at a place above the workpiece holding table 30. After the height of the table plate 31 is appropriately increased, the vertically movable transport member 22 of the fork unit 20 is moved downwardly. Accordingly, the workpiece W′ on the fork 23 can be deposited on the table plate 31.

The skeleton holding table 40 is provided besides the workpiece holding table 30. The skeleton holding table 40 also has a table plate 41 having a surface extending in a horizontal direction, and a lift unit 43 for moving the table plate 41 upwardly and downwardly with the horizontal position of the table plate 31 being maintained.

The area of the table plate 41 is almost the same as that of the base part 32 of the workpiece holding table 30. The table plate 41 is in the form of a rectangle seen from the top, and the upper surface of the table plate 41 is smooth and planer for accepting the skeleton S after the separating operation.

The lift unit 43 can be composed of cross arms (not shown) and one or more hydraulic cylinders (not shown). The cross arms are interposed between the floor F and the table plate 41, with the lower ends of the arms supported on the floor F, and the upper end thereof supported by the table plate 41. The hydraulic cylinder is used for controlling the movement of the cross arms. The lift unit 43 makes the table 41 ascent and descent movements, with horizontally maintaining the table plate 41. It is possible to stop the movement when the table plate 41 reaches an appropriate height.

The truck unit 50 makes a reciprocating movement from the workpiece holding table 30 to the skeleton holding table 40, by the guidance of a track composed of a pair of rails 51 provided on the floor. The rails 51 extend side by side and are spaced apart from each other, with the workpiece holding table 30 and the skeleton holding table 40 being interposed therebetween. The rails 51 are provided beneath the lateral sides of the track unit 50.

As shown in FIG. 1, the track unit 50 has a pair of leg parts 52 provided on the rails and face to each other, and a flame part 53 extending in a horizontal direction by connecting upper portions of the leg parts 52. As seen from FIG. 4, the track unit 50 is configured to have cross-section in the form of a gate. The track unit 50 has a space defined by the leg parts 52 and the flame part 53, which is enough for accepting therein the workpiece holding table 30 in a forward position, and the skeleton holding table 40 in a return position.

Each leg part 52 is in the form of a frame including a horizontally extending bar which is provided along the rail 51. The horizontally extending bar rotatably supports wheals 52a on both ends thereof, with respect to the length, so as to make the track unit 50 movable on the rails 52. Motors 52b are provided on the wheels 52a at the rear ends of the truck unit 50, which are far from the workpiece holding table 30, whereby the track unit 50 makes the reciprocating movement on the rails 51.

On the top of the frame part 53, a product holding table 55 is provided for holding the products P after separating operation. The upper surface of the product holding table 55 is a smooth and plane, having a rectangular shape which extends horizontally. The surface area of the product holding table 55 is almost the same as that of the workpiece W′.

Furthermore, it is possible to provide an outer peripheral wall or a falling-down prevention fence on an outer periphery of the product holding table 55, for preventing the products P from falling down.

A skeleton holding member 60 is provided on a part below the frame part 53 (FIG. 4). The skeleton holding member 60 holds only skeleton S in the workpiece W′ placed on a table plate 31 at a predetermined delivery position. The skeleton holding member 60 has a pair of horizontally moving parts 61 which provided along the lateral sides the track unit 50. The horizontally moving parts 61 are spaced apart from each other and moves so as to be closer to and apart from each other, in the space defined by the truck unit 50. Each of the horizontally moving parts 61 has a plurality of holding members 62 which are arranged in a line in the lengthwise direction of the track unit 50, having spaces therebetween. Each holding member 62 is the composed of opening and closing upper nail 62a and lower nail 62b which are vertically spaced apart from each other, for holding skeleton S therebetween. The upper and lower nails 62a and 62b hold the skeleton S by contacting the upper and lower surfaces thereof.

The upper and lower nails 62a and 62b move so as to be closer to and away from each other. When the track unit 50 moves to the forward position which is above the workpiece holding table 30, the height of the table plate 31 of the table 30 is increased to a skeleton sending-receiving height. In this state, the horizontally moving parts 61 are moved toward each other. Therein, the lower nails 62b are moved from the lateral sides of the table plate 31 and are inserted in the gaps defined by the protrusions 33. The lower nails 62b are moved downwardly transferred, and the upper nails 62a are moved upwardly. Accordingly the skeleton S is held between the upper nails 62a and the lower nail 62b. Accordingly, the skeleton S is interposed between the upper nail 62a and the lower nail 62b.

While the skeleton S being held, the height of the table plate 31 is decreased with the table plate 31 being horizontally maintained. Thus, that only the products S remains on the table plate 31 of the holding table 30. Consequently, the products P and the skeleton S are separated from each other and are maintained at upper and lower positions.

Furthermore, the track unit 50 includes a sensor (not shown), which is for detecting whether or not the workpieces W′ are completely separated into the products P and the skeletons S. The sensor can be made of a photoelectric tube. When the table plate 31 moves downwardly, with the skeleton being held by the skeleton holding member 60, it is possible that the products P are caught by the skeleton S, and that the products P and the skeleton S are not completely separated form each other. The sensor detects whether or not the product(s) is/are inclined with respect to the table plate 31. When it is so detected that the product P above the table is inclined, a control unit of the laser processing apparatus 1 judges that there is a separation failure. While when no inclination of the products P above the table plate 31 is detected, the control unit of the laser processing apparatus 1 judges that separation has been completed.

The operation/control of the laser processing apparatus 1 with the above structure will now be explained.

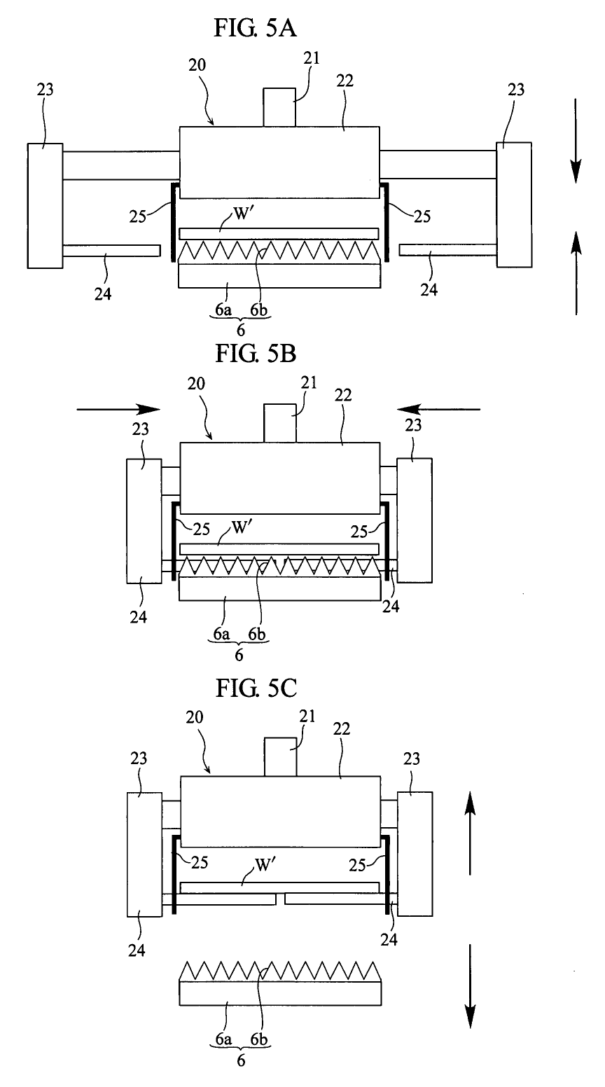

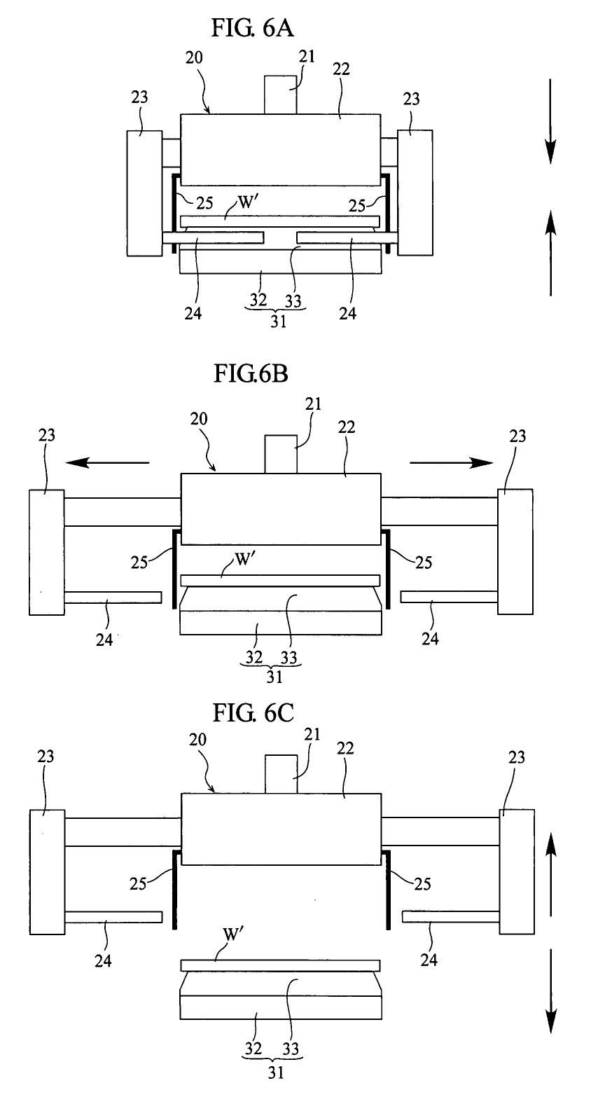

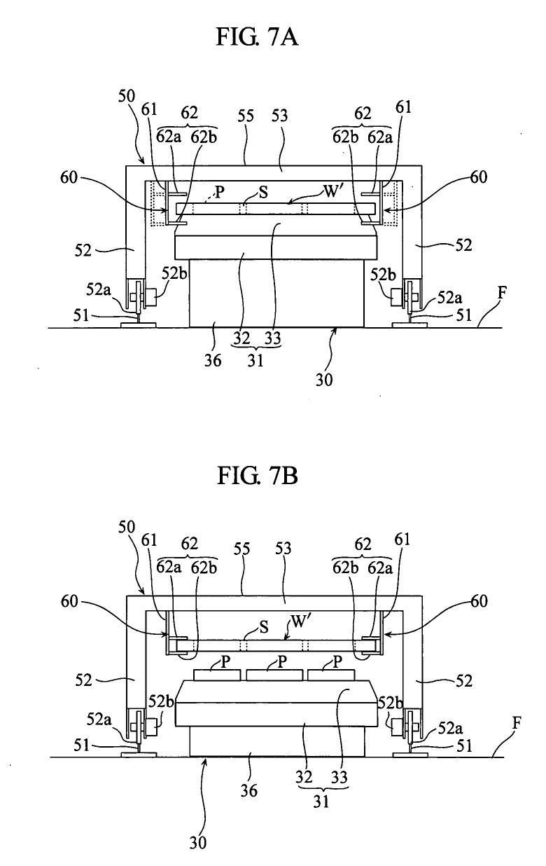

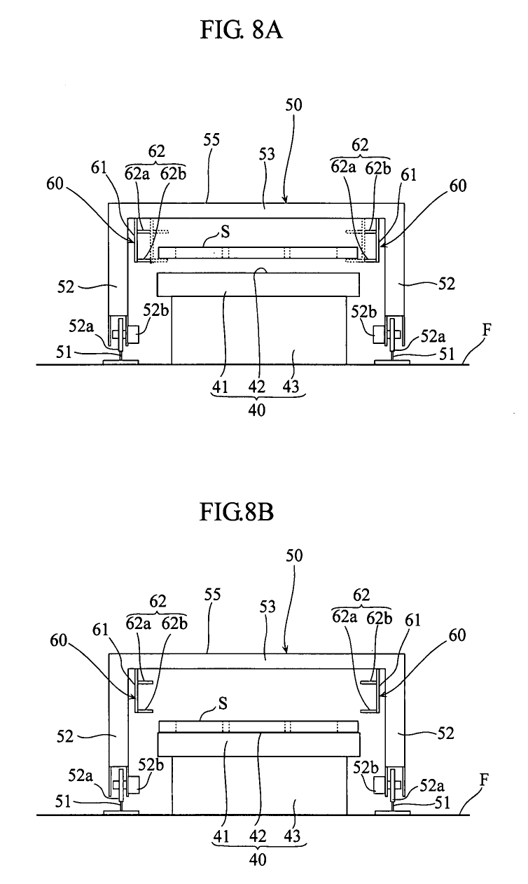

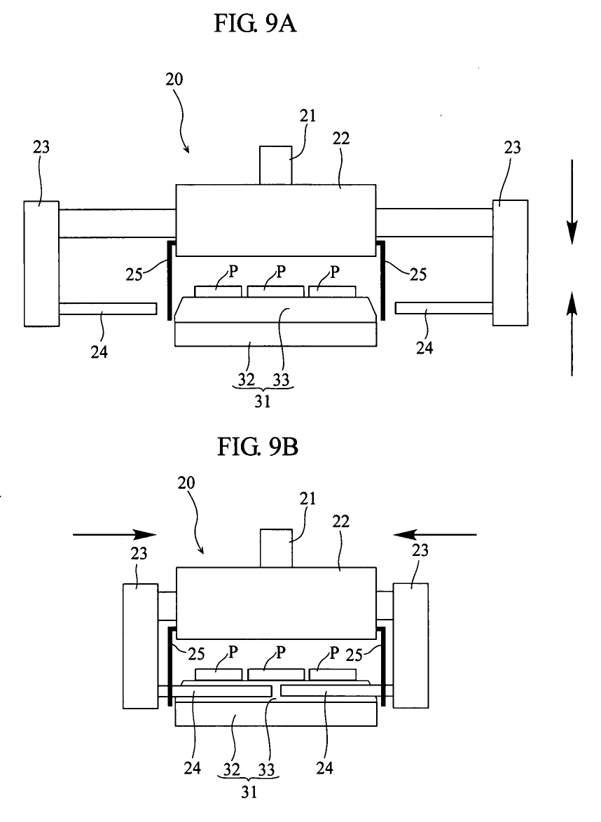

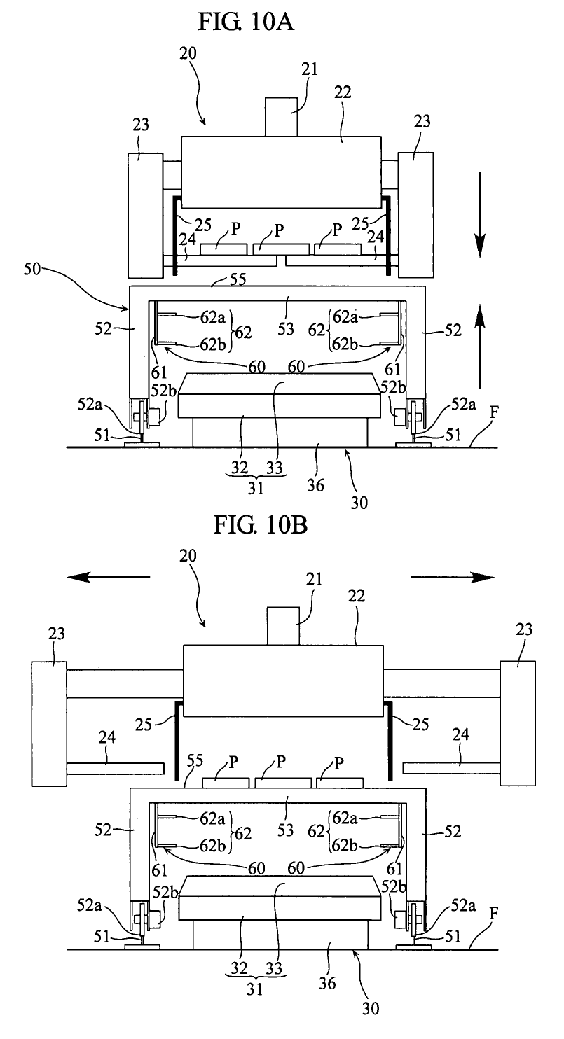

FIGS. 5A to 5C are a schematic diagram for explaining an operation of lifting workpieces W′ from the pallet 6a. FIGS. 6A to 6C are schematic diagrams for explaining an operation of depositing the workpiece W′ on the workpiece holding table 30. FIGS. 7A and 7B are schematic diagrams for explaining an operation of separating a skeleton S from products P. FIGS. 8A and 8B are schematic diagrams for explaining an operation of depositing the skeleton S on the skeleton holding table 40. FIGS. 9A and 9B are schematic diagrams for explaining an operation of lifting the products P from the workpiece holding table 30. FIGS. 10A and 10B are schematic diagrams for explaining an operation of causing the products to fall down and depositing the products on a product holding table 55.

The operation of the laser processing apparatus 1 is controlled by a control unit (not shown) included in the laser processing system 1.

### [Step of Supplying Workpiece W Before Cutting Operation]

In the first place, the transfer unit 15, on which the workpiece W before cutting operation is provided, is moved to a position below the transportation way 7 on the upper stream part 7A. After the horizontally movable transport member 11 of the single-sheet receiving member 10 is transferred to a position below the transportation way 7 on the upper stream part 7A, the vertically movable transport member 12 is moved downwardly and the support member 13 on the vertically movable transport member 12 adsorbs to a workpiece W placed on the transfer unit 15. By upwardly moving the vertically movable transport member 12, a single sheet of the workpiece W is lifted from a stack of workpieces W on the transfer unit 15, and is supported in a suspended state.

Thereafter, the horizontally movable transport member 11 is transferred from the upper stream 7A to the middle part 7B of the transportation way 7. Thus, the workpiece W moves to a position above the pallet changer 6. Then, the height of the vertically movable transport member 12 is decreased, and the workpiece W is deposited on the pallet 6a of the pallet changer 6 after released from the adsorption by the support member 13. The workpiece W on the pallet 6a is sent to a laser processor 2 via the pallet changer 6, and is subjected to a cutting operation.

### [Step of Depositing Workpiece W′ on Workpiece Holding Table]

After the cutting operation by the laser processor 2 is completed, the workpiece W′ on the pallet 6a is transferred to the middle part 7B of the transportation way 7 by the pallet changer 6. The horizontally movable transport member 21 of the fork unit 20 is also moved to a middle part 7B. In this state, the horizontal arms 23, and hence the forks 24 on the upper and lower stream sides are moved apart from each other, so that the distance between forks 24 is made longer than the width of the pallet 6a in the pallet changer 6.

After the vertically movable transport member 22 is moved downwardly and the forks 24 are moved to the lateral sides of the pallet 6a, the horizontal arms 23 are caused to make the closing movement. Then, the tines of the forks 24 are inserted, from the lateral sides of the pallet 6a, into the gaps between the protrusions of the pallet 6a, whereby the upper surfaces of the forks 24 oppose the lower surface of the workpiece W′ (FIG. 5B).

In this state, the vertically movable transport member is moved upwardly for lifting the workpiece W′ from the pallet 6a by the forks 24. The workpiece W′ is held at a predetermined transportation height/position (FIG. 5C).

The horizontally movable transport member 21 of the fork unit 20 moves from the middle part 7B to the downstream part 7C of the transportation way 7, for transporting the workpiece W′ to a position above the workpiece holding table 30. Then, table plate 31 of the workpiece holding table 30 is moved upwardly to a predetermined height for receiving the workpiece W′.

Subsequently, the vertically movable transport member 22 of the fork unit 20 is downwardly moved. Accordingly, the forks 24 are moved downwardly, and the tines of the forks 24 are inserted, from upper parts, into gaps between the protrusions of the table plate 31. The forks 24 are moved so as to have the upper surfaces lower than the tops of the protrusions 33. In this way, the workpiece W′ is deposited on the table plate 31 of the workpiece holding table 30 (FIG. 6A).

Then, the horizontal arms 23 are caused to make the opening movement, for extracting the tines of the forks 24 from the gaps between the protrusions 33 toward the lateral sides of the table plates 31 (FIG. 6B).

Thereafter, the vertically movable transport member 22 is moved upwardly for bringing the forks 24 back to a level higher than the table plate 31. Accordingly, the table plate 31 holds the workpiece W′ thereon. Then, the table plate 31 of the workpiece holding table 30 is moved downwardly to a lowest position (waiting position).

### [Step of Separating and Holding the Workpiece W′ after Processing]

Following the above step, the height of the table plate is again increased to a skeleton receiving-sending position that is lower than the height of the frame part 53 of the truck unit 50. When the track unit 50 moves to the forward position, that is a location below the transportation way 7 at the downstream part 7C, the workpiece holding table 30 is accommodated in the space between the leg parts 52 of the truck unit 50.

In this state, the horizontally moving parts 61 are moved toward each other. The holding members 62 are brought toward the workpiece W′. The lower nails 62b of the holding members 62 are moved from the lateral sides of the table plate 31 into the gaps defined by the protrusions 33, and moved to the lower surface of the skeleton S in the workpiece W′. The upper nails 62a are brought to positions above the lower nails 62b with interposing the skeleton S therebetween (FIG. 7A).

The upper and lower nails 62a and 62b are brought toward each other for holding the skeleton S of the workpiece W′, which is on the table plate 31, from the top and bottom. Then, the table plate 31 is moved downwardly, with only the products P being maintained on the table 31. In this way, the products P and the skeleton S are separated from each other and are held at low and high positions (FIG. 7B).

Based on the detection signal by the sensor (not shown), the control unit of the laser processing apparatus 1 judges whether or not the separation has been completed. When it is determined that the separation is completed, a regular depositing process follows, wherein the products P and the skeleton S are separately deposited on the product holding table 55 and the skeleton holding table 40. On the other hand, when it is determined that the separation was failed, an irregular depositing process follows, wherein the workpieces W′ are deposited on the product holding table 55.

### [Regular Depositing Process]

When it is judged that the separation is completed, based on the detection signal from the sensor (not shown), the truck unit 50 moves to a return position, with the products P being placed on the table plate 31 of the workpiece holding table 30, and the skeleton S being maintained by the skeleton holding member 60. In this way, the skeleton S is transferred to a position above the skeleton holding table 40 (FIG. 8A).

Then, the table plate 41 of the skeleton holding table 40 is moved to a predetermined height. The upper and lower nails 62a and 62b of the holding members 62 are moved away, in a vertical direction. In this state, the skeleton S is released from the fixation by the holding member 62. Furthermore, the horizontally moving parts 61 are also moved away from each other in a horizontal direction. Accordingly, the skeleton S is dropped from the skeleton holding member 60, and deposited on the table plate 41 (FIG. 8B).

Subsequently, the table plate 31 of the workpiece holding table 30 moves upwardly and stops at a product sending-receiving height. Then, the vertically movable transport member 22 of the fork units 20 are downwardly moved, and each of the forks 24 are moved to each lateral side of the table plate 31 (FIG. 9A). Then, the tines of the forks 24 are inserted into the gaps determined by the protrusions 33 of the table plate 31, from the lateral sides of the table plate 31, by the closing movement of the arms 23. Therefore, the upper surfaces of the forks 24 oppose the lower surfaces of the products P (FIG. 9B).

The vertically movable transport member 22 is moved upwardly for lifting the products P on the table plate 31 by the forks 24. Here, the forks 24 are maintained at a position higher than the product holding table 55 of the truck unit 50.

Furthermore, the track unit 50 is moved to a forward position, which is below the forks 24. The horizontal arms 23 are moved apart from each other. (FIG. 10A). When the forks 24 are moved apart from each other, the products P on the forks 24 tend to remain on the forks 24. However, the products S on the forks 24 contact the back plates 25, and only the forks 24 are extracted toward the lateral sides of the truck unit 50. The products P fall down from the forks 24, and are deposited on the upper surface of the product holding table 55 (FIG. 10B).

Accordingly, the workpiece W′ is separated into the products P and the skeleton S, and separately held on the product holding table 55 and the skeleton holding table 40.

### [Irregular Depositing Process]

When it is judged that the separation failure was caused, based on the detection signal from the sensor (not shown), the table plate 31 of the workpiece holding table 30 moves upwardly to a predetermined skeleton sending-receiving height again, and the skeleton S is released from the fixation by the holding member. Then, the workpiece W′ including the products P and the skeleton S is transferred again to the table plate 31 of the workpiece holding table 30.

After the table plate 31 is downwardly moved, the truck unit 50 is transferred from the forward position to the return position. Then, the height of table plate 31 is increased again and maintained at the product receiving-sending height.

The vertically movable transport member 22 of the fork unit 20 is moved downwardly, and the forks 24 are transferred to the lateral sides of the table plate 31. Then, the horizontal arms 23 make a closing movement. Then, the tines of the forks 24 are inserted into the gaps determined by the protrusions 33 of the table plate 31, from the lateral sides of the table plate 31, by the closing movement of the arms 23. Therefore, the upper surfaces of the forks 24 oppose the lower surfaces of the workpiece W′ on the table plate 31.

In this state, the vertically movable transport member 22 is moved upwardly for lifting the workpiece W′ by the forks 24. The workpiece W′ is held at a predetermined transportation height/position, which is higher than the level of the product holding table 55 of the truck unit 50. The truck unit 50 is moved to the forward position, which is below the forks 24, and stopped there. Then, the horizontal arms 23 are moved away from each other.

Accordingly, the workpiece W provided on the forks 24 are brought into contact with the back plates 25 of the fork units 20, so that only the forks 24 are extracted toward the lateral sides of the truck unit 50. In this way, the products P fall down from the forks 24, and are deposited on the upper surface of the product holding table 55 (FIG. 10B).

Eventually, when the separation failure is caused, it is not necessary to stop the entire operation of the laser processing apparatus 1. Since the operation can be continued, it is possible to increase the productivity in the processing apparatus 1.

By using the laser processing apparatus 1 of the embodiment of the present invention, the products P and the skeleton S are separated from each other, wherein the skeleton S in the workpiece W′ is held by the skeleton holding member 60, and simultaneously the height of the table plate 31 of the workpiece holding table 30 is decreased. Namely, the products P are separated from the skeleton S, by lifting the skeleton S to be higher than the products P. In the apparatus 1 of the invention, it is possible that the products P is separated from the skeleton S, with the horizontal position of the workpiece W′ being maintained. Hence, it is possible to prevent a separation failure, that happens because the workpiece W′ is inclined and the products P are caught by the skeleton S.

Furthermore, it is possible to remodel an existing laser processing apparatus having a fork unit and a workpiece holding table, into the laser processing apparatus 1 of the embodiment of the present invention, only by installing the truck unit 50 having the skeleton holding member 60, without a large-scale reconstruction. Accordingly, the existing laser processing apparatus can be effectively used by a short-term reconstruction which can be carried out easily at a low price.

In addition to the above, it is possible to minimize the size of the apparatus, in comparison with known apparatus, since the truck unit 50 makes a simple movement between the forward position and the return position. Then, small space is required for installation, and it is possible in a factory that the layout of the apparatus can be modified in many ways.

Furthermore, it is possible to provide a further truck unit 50 and a further skeleton holding table 40, and to easily enlarge the number of workpieces to be subjected to a cutting operation by the laser processing apparatus 1, depending on the length of the rails 51.

Moreover, it is possible that the truck unit 50 includes a vertically moving member for moving the skeleton holding member 60 upwardly and downwardly. Based on this structure, and the skeleton held by the skeleton holding member 60 can be lifted up by the vertical moving member, without lowering the table plate 31. Accordingly, the skeleton is lifted from the workpiece holding table 30 and the skeleton S and the products P are separated from each other.

In the above embodiment, the fork unit 20 is used also as a product holding member. However, it is possible that a further member is provided as the product holding member, separately from the fork unit.

The present invention being thus described, it will be clearly understood that the same may be varied in many ways. Such variations are not to be regarded as a departure from the spirit and scope of the present invention, and all such modification as would be easily understood to one skilled in the art are intended to be included within the scope of the appended claims.

What is claimed is:

1. A separating and holding apparatus for separating products which have been cut out of a workpiece and a skeleton of the workpiece from each other, and for carrying and holding the products and the skeleton, comprising:
a workpiece holding table for holding the workpiece including the products and the skeleton;
a skeleton holding table for holding the skeleton, the skeleton holding table being provided beside the workpiece holding table;
a truck unit which moves horizontally between a forward position and a return position, an upper part of the truck unit being located above the workpiece holding table and the skeleton holding table in the forward position and the return position, respectively;
a product holding table for holding the products separated from the workpiece, the product holding table being provided on the upper part of the truck unit;
a skeleton holding member for holding the skeleton provided on the skeleton holding table at the forward position, the skeleton holding member provided below the upper part of the truck unit, for holding the skeleton at a height relatively higher than that of the workpiece holding table so as to be spaced apart from the products, for carrying the skeleton to the return position by the movement of the truck unit, and for depositing the skeleton on the skeleton holding table by releasing the skeleton therefrom at the return position; and
a product holding member for holding the products provided on the workpiece holding table by lifting the products, when the truck unit is provided at the return position at a height higher than that of the product holding table, and for causing the products to fall down to the product holding table when the truck unit is provided at the forward position.

2. The separating and holding apparatus for separating products as claimed in claim 1, wherein the workpiece holding table includes a table plate on which the workpiece is provided, and a lift unit for moving the table plate upwardly and downwardly, the skeleton being separated from the products by having the lift unit decrease the height of the table plate which holds the products thereon while the skeleton being held by the skeleton holding member.

3. The separating and holding apparatus for separating products as claimed in claim 2, wherein the table plate has an upper surface having a plurality of protrusions, each of the protrusions extending upwardly, the protrusions being arranged throughout the upper surface,
the product holding member including a vertically movable transport member which moves above the table plate, a horizontally movable transport member which is supported by the vertically movable transport member horizontally moving toward and away from the table plate on the sides of the table plate, and forks which are supported by the horizontally movable transport member extending in a horizontal direction, tines of the forks being inserted into gaps defined by the protrusions when the forks are brought toward each other due to the movement of the horizontally movable transport member,
the products being lifted from the workpiece holding table by the product holding member, with the tines being inserted into the gaps when the forks are brought toward each other, the forks being inserted between the table plate and the products, and the horizontally movable transport member being lifted up with the products being held on the forks.
